(19) United States
(12) Patent Application Publication
(10) Pub. No.: US 2022/0342987 A1
(43) Pub. Date: Oct. 27, 2022

(54) Virtual Machine Orchestration Spoofing Attack Mitigation

(71) Applicant: AT&T Intellectual Property I, L.P., Atlanta, GA (US)

(72) Inventors: Joseph Soryal, Glendale, NY (US); Dylan C. Reid, Atlanta, GA (US)

(73) Assignee: AT&T Intellectual Property I, L.P., Atlanta, GA (US)

(21) Appl. No.: 17/236,136

(22) Filed: Apr. 21, 2021

(51) Int. Cl. G06F 21/55

(52) U.S. Cl. CPC G06F 21/554

(57) ABSTRACT

The concepts and technologies disclosed herein are directed to virtual machine (“VM”) orchestration spoofing attack mitigation. According to one aspect disclosed herein, an anti-spoofing controller (“ASC”) can determine a target memory location in which to instantiate a new VM. The ASC can determine a challenge for a physically unclonable function (“PUF”) associated with the target memory location. The ASC can provide the challenge to the PUF, and in response, can receive and store an output value from the PUF. The ASC can instruct an orchestrator to instantiate the new VM in the target memory location. The ASC can provide the challenge to the new VM, which can forward the challenge to the orchestrator. The ASC can receive, from the orchestrator, a response to the challenge, and can determine whether the response passes the challenge. If the response does not pass the challenge, the ASC can decommission the orchestrator.

### BACKGROUND

Cloud computing allows dynamically scalable virtualized resources to host applications and services. Cloud computing assures an appropriate level of resources are available to power software applications when and where the resources are needed in response to demand. As a result, cloud computing allows entities to respond quickly, efficiently, and in an automated fashion to rapidly changing business environments.

The ubiquitous nature of cloud computing makes cloud computing an ideal target for malicious attacks. An attacker may infiltrate the orchestration functionality of a cloud computing platform to spoof legit orchestrators and/or other management/controller elements to instantiate malicious virtual machines and/or other virtualized elements such as virtual networking functions (“VNFs”).

### SUMMARY

The concepts and technologies disclosed herein are directed to virtual machine (“VM”) orchestration spoofing attack mitigation. According to one aspect disclosed herein, an anti-spoofing controller (“ASC”) can determine a target memory location in which to instantiate a new VM. The ASC can determine a challenge for a physically unclonable function (“PUF”) associated with the target memory location. The ASC can provide the challenge to the PUF, and in response, can receive and store an output value from the PUF. The ASC can instruct an orchestrator to instantiate the new VM in the target memory location. The ASC can provide the challenge to the new VM, which can forward the challenge to the orchestrator. The ASC can receive, from the orchestrator, a response to the challenge, and can determine whether the response passes the challenge.

In response to determining that the response does not pass the challenge, the ASC can instruct a master orchestrator to decommission the orchestrator. In some embodiments, the ASC can instruct the orchestrator to instantiate the new VM in a quarantine portion of the target memory location. In these embodiments, in response to determining that the response passes the challenge, the ASC can instruct the master orchestrator to remove the new VM from the quarantine portion of the target memory location.

In some embodiments, the ASC can intercept a request for the new VM. The request can be generated by the orchestrator.

In some embodiments, the ASC can determine a plurality of challenges for the PUF associated with the target memory location. The plurality of challenges can include different challenges and/or the same challenge under different conditions. For example, the conditions can be or can include conditions based upon environmental characteristics such as temperature, humidity, ambient noise, combinations thereof, and/or the like.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B are block diagrams illustrating aspects of illustrative operating environments in which various concepts and technologies disclosed herein can be implemented.

FIG. 2 is a flow diagram illustrating aspects of a method for mitigating virtual machine orchestration spoofing, according to an illustrative embodiment.

FIG. 3 is a flow diagram illustrating aspects of another method for mitigating virtual machine orchestration spoofing, according to an illustrative embodiment.

FIG. 4 is a flow diagram illustrating aspects of another method for mitigating virtual machine orchestration spoofing, according to an illustrative embodiment.

FIG. 5 is a block diagram illustrating an example computer system capable of implementing aspects of the embodiments presented herein.

FIG. 6 is a block diagram illustrating aspects of an illustrative network functions virtualization (“NFV”) platform capable of implementing aspects of embodiments of the concepts and technologies disclosed herein can be implemented.

FIG. 7 is a diagram illustrating a network capable of implementing aspects of the concepts and technologies disclosed herein

FIG. 8 is a block diagram illustrating a machine learning system capable of implementing aspects of the concept and technologies disclosed herein.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, vehicles, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of the concepts and technologies disclosed herein for venue seat assignment based upon hearing profiles will be described.

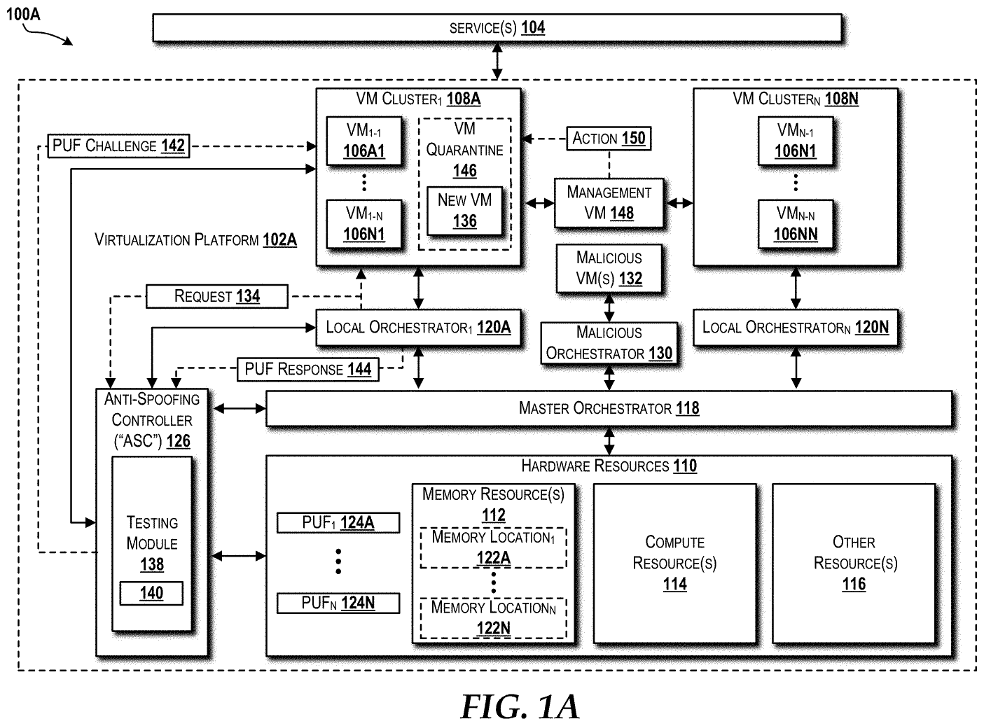

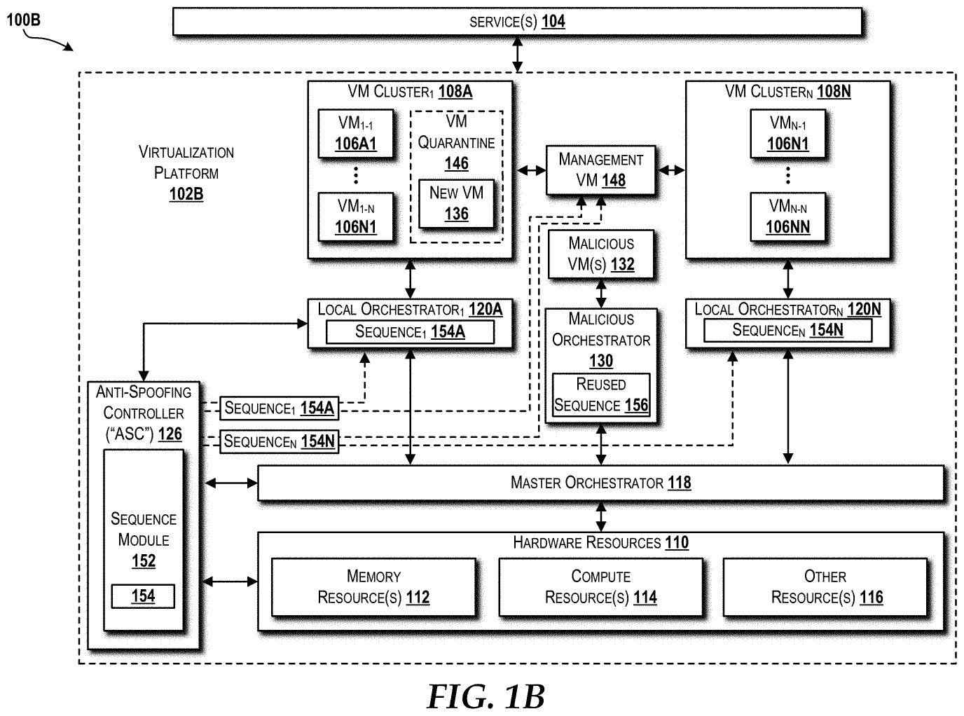

Referring now to FIG. 1, aspects of an illustrative operating environment 100A for various concepts disclosed herein will be described. It should be understood that the operating environment 100A and the various components thereof have been greatly simplified for purposes of description. Accordingly, additional or alternative components of the operating environment 100A can be made available without departing from the embodiments described herein. The illustrated operating environment 100A includes a virtualization platform 102A that facilitates the virtualization of resources to provide, at least in part, one or more services 104 (hereinafter referred to collectively as “services 104” or individually as “service 104”). The virtualization platform 102A can support the creation, deployment, and management of one or more virtual machines (“VMs”) 106 operating in one or more VM clusters 108 to provide the services 104. In particular, a VM cluster₁ 108A can include VMs 106A1-106N1 and a VM cluster_{N} 108N can include VMs 106N1-106NN. The VMs 106 will be referred to herein collectively as “VMs 106” or individually as “VM 106.” The VM clusters 108 will be referred to herein collectively as “VM clusters 108” or individually as “VM cluster 108.” Although the VMs 106 are shown in the VM clusters 108, other deployment configurations are contemplated.

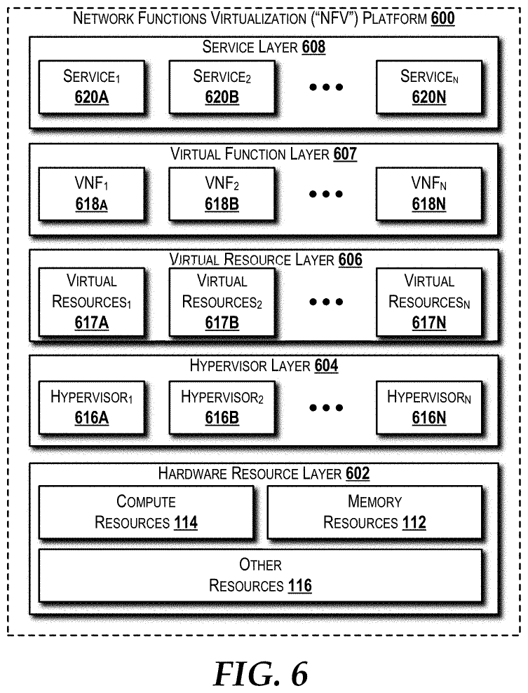

In some embodiments, the services 104 can be provided in accordance with any cloud service models, such as software as a service (“SaaS”), platform as a service (“PaaS”), infrastructure as a service (“IaaS”), and the like. In some embodiments, the services 104 can be telecommunications services that utilize the virtualization platform 102A to virtualize network components. In these embodiments, the VMs 106 can be or can include one or more virtual network functions (“VNFs”). As such, the virtualization platform 102A can be a network functions virtualization (“NFV”) platform (best shown in FIG. 6) that can provide one or more software-defined networks (“SDNs”) to support the services 104. Those skilled in the art will appreciate the numerous services 104 that can be provided, at least in part, by the virtualization platform 102A. Accordingly, the examples provided herein should not be construed as being limiting in any way.

The virtualization platform 102A includes a plurality of hardware resources 110 (“hardware resources 110”). The hardware resources 110 can include one or more memory resources 112, one or more compute resources 114, and one or more other resources 116. The hardware resources 110 can be embodied as one or more physical servers, otherwise known as bare metal servers, that each include one or more of the memory resources 112, one or more of the compute resources 114, and/or one or more of the other resources 116.

The compute resource(s) 114 can include one or more hardware components that perform computations to process data and/or to execute computer-executable instructions of one or more application programs, one or more operating systems, and/or other software. In particular, the compute resources 114 can include one or more central processing units (“CPUs”) configured with one or more processing cores. The compute resources 114 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 114 can include one or more discrete GPUs. In some other embodiments, the compute resources 114 can include CPU and GPU components that are configured in accordance with a co-processing CPU/GPU computing model, wherein the sequential part of an application executes on the CPU and the computationally-intensive part is accelerated by the GPU processing capabilities. The compute resources 114 can include one or more system-on-chip (“SoC”) components along with one or more other components, including, for example, one or more of the memory resources 112, and/or one or more of the other resources 116. In some embodiments, the compute resources 114 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 114 can be or can include one or more hardware components architected in accordance with an ARM architecture, available for license from ARM HOLDINGS of Cambridge, United Kingdom. Alternatively, the compute resources 114 can be or can include one or more hardware components architected in accordance with an x86 architecture, such an architecture available from INTEL CORPORATION of Mountain View, Calif., and others. Those skilled in the art will appreciate the implementation of the compute resources 114 can utilize various computation architectures, and as such, the compute resources 114 should not be construed as being limited to any particular computation architecture or combination of computation architectures, including those explicitly disclosed herein.

The memory resource(s) 112 can include one or more hardware components that perform storage/memory operations, including temporary or permanent storage operations. In some embodiments, the memory resource(s) 112 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 114.

The other resource(s) 116 can include any other hardware resources that can be utilized by the compute resources(s) 114 and/or the memory resource(s) 112 to perform operations described herein. The other resource(s) 116 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

A master orchestrator 118 can coordinate with the hardware resources 110 to allocate the memory resources 112, the compute resources 114, and the other resources 116 on which to deploy the VMs 106. The master orchestrator 118 can coordinate with one or more local orchestrators 120A-120N (referred to herein collectively as “local orchestrators 120” or individually as “local orchestrator 120”), which can provide orchestration functionality over the VM clusters 108A-108N, respectively. Alternative embodiments of the virtualization platform 102A may utilize individual VMs 106 that are not clustered and may utilize a single orchestrator, such as the master orchestrator 118 to allocate the hardware resources 110. In some embodiments, the master orchestrator 118 and/or the local orchestrators 120 can be configured in accordance with the Open Networking Automation Platform (“ONAP”), and as such can perform ONAP orchestration functions, including arranging, sequencing, and implementing tasks based upon rules and/or policies to coordinate the creation, modification, or removal of logical and physical resources in a managed environment, such as provided by the virtualization platform 102A. The master orchestrator 118 can manage orchestration at the top level and facilitates additional orchestration among lower level controllers, such as the local orchestrators 120.

The master orchestrator 118 can perform end-to-end service instance provisioning (i.e., provisioning instances of the service(s) 104). The master orchestrator 118 can instantiate and release VMs 106 (e.g., embodied as VNFs), as well as perform migration and relocation of the VMs 106 in support of end-to-end service instantiation, operations, and management. The master orchestrator 118 can be triggered by service requests received from an external entity (not shown).

The master orchestrator 118 can be aware of the state of lower level service controllers, such as the local orchestrators 120. For example, in some embodiments, the master orchestrator 118 is in communication with the local orchestrators 120 that control, at least in part, the operation of one or more VMs 106 at the nodal or VM cluster level. These VM-specific and VM cluster-specific service controllers can be tracked by the master orchestrator 118 to maintain synchronized states to extract information. The master orchestrator 118 uses this information to dynamically allocate and/or alter the resource utilization on-demand within a given VM 106 or across multiple VMs 106 during the course of service changes or upgrades, error conditions, failover situations, and the like.

The memory resources 112 can include one or more memory locations 122A-122N (referred to herein collectively as “memory locations 122” or individually as “memory location 122”). Each of the memory locations 122 can be associated with a physically unclonable function (“PUF”) 124A-124N, respectively (referred to herein collectively as “PUFs 124” or individually as “PUF 124”). The PUFs 124 are physical security devices that produce unclonable and inherent instance-specific measurements of physical objects, such as silicon-based components. The PUFs 124 can be integrated within the circuitry of one or more of the memory resources 112, one or more of the compute resources 114, and/or one or more other resources 116. Alternatively, the PUFs 124 can be implemented separate from but associated with one or more of the memory resources 112, one or more of the compute resources 114, and/or one or more other resources 116. In some embodiments, the PUFs 124 can be a standalone integrated circuit or part of an SoC. The PUFs 124, in some other embodiments, can be implemented in a field programmable gate array (“FPGA”). For ease of explanation, the PUFs 124 will be described as being associated with the memory locations 122 of the memory resources 112. This, however, should not be construed as being limiting in any way.

The PUFs 124 rely on variances in physical properties that are inherently part of the manufacturing processes. Since the manufacturing process cannot control the variances, the resulting device is unique and cannot be cloned. The PUFs 124 can convert these variations into a pattern of binary digits that is unique to the associated component. In this manner, the PUFs 124 create a hardware fingerprint that is akin to a biometric fingerprint of a human. The concept of PUFs 124 is well-known, including the manufacturing, deployment, and use thereof. As such, additional general details about the PUFs 124 are not provided herein. Those skilled in the art, however, will appreciate novel use of the PUFs 124 in context of the concepts and technologies disclosed herein.

The PUFs 124 can enable an anti-spoofing controller (“ASC”) 126 to detect a malicious orchestrator 130 and/or one or more malicious VMs 132, which can be controlled by the malicious orchestrator 130. In particular, by tying together orchestrator VM authentication with the hardware fingerprint (provided by the PUFs 124) of the memory location 122, a malicious entity (e.g., a hacker) cannot duplicate the PUF 124 and therefore the presence of the malicious orchestrator 130 and/or the malicious VMs 132 can be detected.

The ASC 126 can intercept a request 134 for a new VM 136. In the illustrated example, the request 134 is generated and sent by the local orchestrators 120A, although certain embodiments may delegate such functionality to the master orchestrator 118. In any case, the ASC 126 can determine a target memory location of the memory locations 122 for the new VM 136. The ASC 126 also can obtain the PUF 124, or more particularly, a PUF identifier associated with the PUF 124 that, in turn, is associated with the target memory location (hereinafter “target memory location 122”).

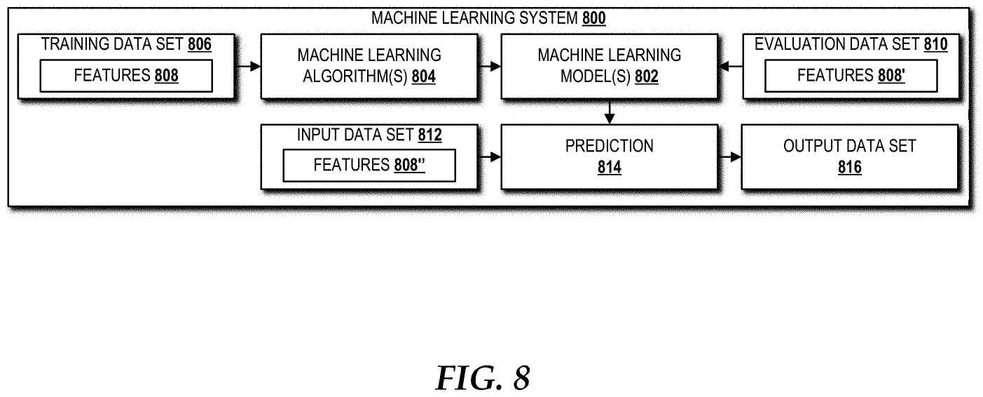

The illustrated ASC 126 includes a testing module 138 that can be used to test various output values 140 of the PUF 124 based upon a plurality of PUF challenges 142 presented to the PUF 124. The PUF challenge 142 includes a sequence of bits as input to the PUF 124. The PUF 124 receives the PUF challenge 142 and generates a PUF response 144 as output. The combination of a given PUF challenge 142 and a given PUF response 144 constitutes a challenge-response pair. In some embodiments, the testing module 138 can test the output values 140 of the PUF 124 based upon the PUF challenges 142 and one or more conditions. For example, the conditions can be or can include conditions based upon environmental characteristics such as temperature, humidity, ambient noise, combinations thereof, and/or the like. In some embodiments, the testing module 138 can implement machine learning techniques to predict the output values 140 of the PUF 124 as a function of time for an average or predetermined duration of the new VM 136. An example machine learning system that can be included as part of the ASC 126 or utilized by the ASC 126 is illustrated and described herein with reference to FIG. 8. The ASC 126 can store the output values 140 for the PUF challenges 142. The output values 140 can be used to compare the PUF responses 144 received from the local orchestrator 120 in response to a given PUF challenge 142, as will be described in greater detail below.

After the ASC 126 tests the PUF 124 under different conditions, the ASC 126 can instruct the local orchestrator 120 to create the new VM 136. Since the ASC 126 does not yet know whether the local orchestrator 120 is a malicious orchestrator 130 and whether the new VM 136 is a malicious VM 132, the ASC 126 can instruct the local orchestrator 120 to create the new VM 136 in a VM quarantine 146. The VM quarantine 146 is a logical quarantining mechanism that allows the new VM 136 to be instantiated in the target memory location 122 but limits the functionality of the new VM 136, such as preventing the new VM 136 from coordinating with other VMs, such as the VMs 106 in the same or different VM clusters 108. As noted above, the VMs 106 may be deployed individually and not clustered or pooled in any manner. The new VM 136 can be relegated to the VM quarantine 146 in these instances as well. It is contemplated that the ASC 126 can implement one or more policies to regulate the functionality of any new VM 136 deployed in the VM quarantine 146.

The ASC 126 can provide the new VM 136 with one or more of the PUF challenges 142 that the ASC 126 previously tested using the PUF 124 associated with the target memory location 122 of the new VM 136. The new VM 136 can receive the PUF challenge 142 and forward the PUF challenge 142 to the local orchestrator 120. The local orchestrator 120 can provide the PUF response 144 to the ASC 126. The ASC 126 can receive the PUF response 144 and determine whether the PUF response 144 satisfies the PUF challenge 142. In other words, the ASC 126 can determine whether the PUF response 144 matches the output value for the specific PUF challenge 142. If the ASC 126 determines that the PUF response 144 satisfies the PUF challenge 142, the ASC 126 can instruct the local orchestrator 120 to remove the new VM 136 from the VM quarantine 146 and allow the new VM 136 to communicate with other VMs, such as the VMs 106 in the same VM cluster 108. If instead the ASC 126 determines that the PUF response 144 does not satisfy the PUF challenge 142, the ASC 126 can instruct the master orchestrator 118 to decommission the local orchestrator 120 and tear down the new VM 136. In some embodiments, the ASC 126 can instruct the master orchestrator 118 to instantiate a new local orchestrator 120 for the VM cluster 108, including the VMs 106. Alternatively, the master orchestrator 118 can delegate local orchestration functions to an existing local orchestrator 120.

In some implementations, the VMs 106 and/or the VM clusters 108 can be managed, at least in part, by one or more management VMs 148 (referred to herein collectively as “management VMs 148” or individually as “management VM 148”). The management VM 148 can command one or more of the VMs 106 to perform one or more actions 150. In some embodiments, the management VM 148 can be or can include a hypervisor. The ASC 126 can be used to ensure that the management VM 148 is not spoofed. In particular, prior to the VM 106 executing the action(s) 150, the VM 106 can contact the ASC 126, which can provide the VM 106 with the PUF challenge 142 to be forwarded to the management VM 148. When the VM 106 receives the PUF response 144 from the management VM 148, the VM 106 can then forward the PUF response 144 to the ASC 126 for validation. If the PUF response 144 is valid, this indicates the management VM 148 has not been spoofed, and the ASC 126 can notify the VM 106 that it may execute the action(s) 150.

Turning now to FIG. 1B, aspects of another illustrative operating environment 100B for various concepts disclosed herein will be described. It should be understood that the operating environment 100B and the various components thereof have been greatly simplified for purposes of description. Accordingly, additional or alternative components of the operating environment 100B can be made available without departing from the embodiments described herein. The illustrated operating environment 100B includes another virtualization platform 102B that includes elements similar to those described above with respect to the virtualization platform 102A. in particular, the virtualization platform 102B can provide the services 104 via the VMs 106, which may operate in one or more of the VM clusters 108, and can be instantiated using the hardware resources, including the memory resources 112, the compute resources 114, and the other resources 116. The master orchestrator 118 is also shown operating in communication with the local orchestrators 120. The ASC 126 is also shown, but in the embodiment illustrated in FIG. 1B, the ASC 126 includes a sequence module 152 that can be used to generate unique sequences 154 and broadcast the sequences 154 to legitimate orchestrators such as the local orchestrators 120. In the illustrated example, the ASC 126 provides a first sequence (“sequence₁ 154A”) to the local orchestrator₁ 120A and an N^{th} sequence (“sequence_{N} 154N”) to the local orchestrator_{N} 120N. The ASC 126 also can provide the sequences 154 to a virtualization layer (best shown in FIG. 6). The local orchestrators 120 are to provide at least one of the sequences 154 to the virtualization layer in order for the virtualization layer to dedicate the hardware resources 110 to create the new VM 136. If the local orchestrator 120 is unable to provide at least one of the sequences 154, the virtualization layer can deny the request for the new VM 136. Moreover, each of the sequences 154 can only be used once. A spoofed orchestrator, such as the malicious orchestrator 130 in the illustrated example, may try to reuse one of the sequences 154 (shown as “reused sequence 156”), which may trigger an alarm for the ASC 126 to take remedial action. The number of the sequences 154 available at any given time is small (e.g., equal to the number of local orchestrators 120) to increase the chance of reuse by the malicious orchestrator 130.

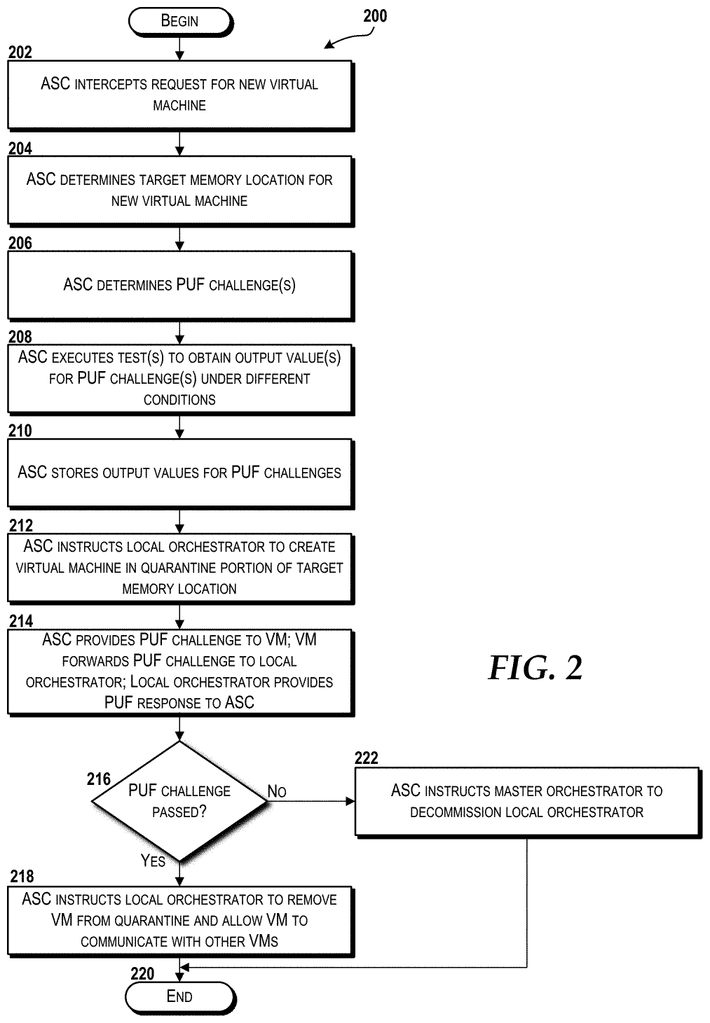

Turning now to FIG. 2, a flow diagram illustrating aspects of a method 200 for mitigating VM orchestration spoofing will be described, according to an illustrative embodiment. The method 200 will be described with additional reference to FIG. 1A. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems or devices, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing one or more processors, and/or one or more other computing systems, network components, and/or devices disclosed herein to perform operations.

For purposes of illustrating and describing some of the concepts of the present disclosure, the methods disclosed herein are described as being performed, at least in part, by one or more processing components, of one or more software modules, applications, and/or other software described herein. It should be understood that additional and/or alternative devices can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the ASC 126 intercepts the request 134 for the new VM 136. From operation 202, the method 200 proceeds to operation 204. At operation 204, the ASC 126 determines the target memory location 122 for the new VM 136. From operation 204, the method 200 proceeds to operation 206. At operation 206, the ASC 126 determines the PUF challenges 142. From operation 206, the method 200 proceeds to operation 208. At operation 208, the ASC 126 executes one or more tests to obtain the output value(s) 140 for the PUF challenges 142. In some embodiments, the ASC 126 can execute the tests under different conditions for the same challenge. This can further enhance the security provided by the PUFs 124. From operation 208, the method 200 proceeds to operation 210. At operation 210, the ASC 126 stores the output values 140 for the PUF challenges 142.

From operation 210, the method 200 proceeds to operation 212. At operation 212, the ASC 126 instructs the local orchestrator 120 to create the new VM 136 in the VM quarantine 146. From operation 212, the method 200 proceeds to operation 214. At operation 214, the ASC 126 provides the new VM 136 with the PUF challenge 142, and the new VM 136 forwards the PUF challenge 142 to the local orchestrator 120. The local orchestrator 120 provides the PUF response 144 to the ASC 126. From operation 214, the method 200 proceeds to operation 216. At operation 216, the ASC 126 determines if the PUF response 144 satisfies the PUF challenge 142 (i.e., the PUF response 144 is the same as the output value 140 previously stored for the PUF challenge 142 provided at operation 214). If the ASC 126 determines that the PUF response 144 satisfies the PUF challenge 142, the method 200 proceeds to operation 218. At operation 218, the ASC 126 instructs the local orchestrator 120 to remove the new VM 136 from the VM quarantine 146 and allow the new VM 136 to communicate with other VMs, such as the VMs 106. From operation 218, the method 200 proceeds to operation 220. The method 200 can end at operation 220. Returning to operation 216, if the ASC 126 determines that the PUF response 144 does not satisfy the PUF challenge 142, the method 200 proceeds to operation 222. At operation 222, the ASC 126 instructs the master orchestrator 118 to decommission the local orchestrator 120 (i.e., the local orchestrator 120 is a malicious orchestrator 130). In some embodiments, the master orchestrator 118 can also decommission the new VM 136 and, if desired, the associated VM cluster 108. From operation 222, the method 200 proceeds to operation 224. The method 200 can end at operation 220.

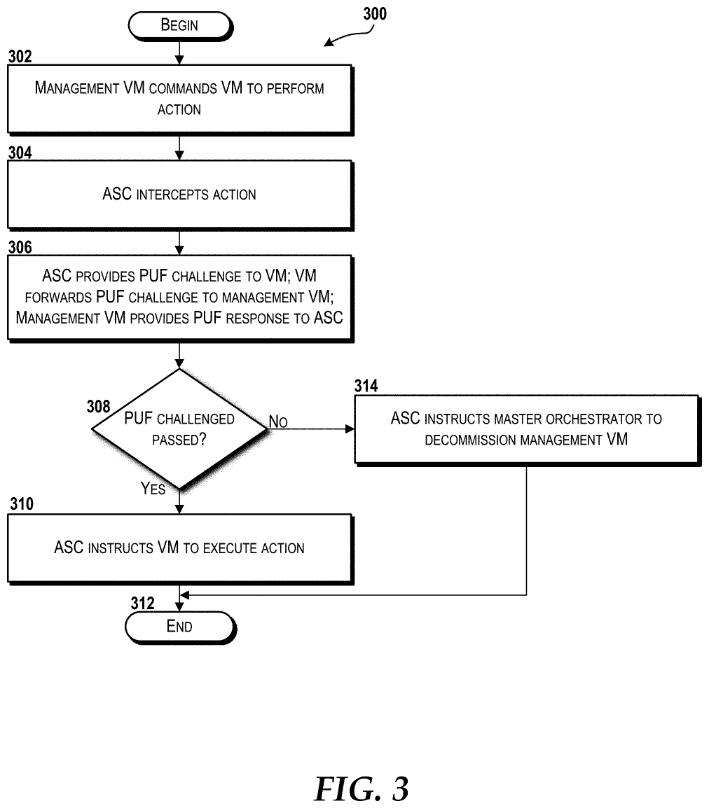

Turning now to FIG. 3, another method for mitigating VM orchestration spoofing will be described, according to an illustrative embodiment. The method 300 will be described with additional reference to FIG. 1A. The method 300 begins and proceeds to operation 302. At operation 302, the management VM 148 commands one of the VMs 106 to perform the action 150. From operation 302, the method 300 proceeds to operation 304. At operation 304, the ASC 126 intercepts the action 150.

From operation 304, the method 300 proceeds to operation 306. At operation 306, the ASC 126 provides the VM 106 with the PUF challenge 142. Also at operation 306, the VM 106 forwards the PUF challenge 142 to the management VM 148. The management VM 148 provides the PUF response 144 to the ASC 126. From operation 306, the method 300 proceeds to operation 308. At operation 308, the ASC 126 determines if the PUF response 144 satisfies the PUF challenge 142. If the ASC 126 determines that the PUF response 144 satisfies the PUF challenge 142, the method 300 proceeds to operation 310. At operation 310, the ASC 126 instructs the VM 106 to execute the action 150. From operation 310, the method 300 proceeds to operation 312. The method 300 can end at operation 312.

Returning to operation 308, if the ASC 126 determines that the PUF response 144 does not satisfy the PUF challenge 142, the method 300 proceeds to operation 314. At operation 314, the ASC 126 instructs the master orchestrator 118 to decommission the management VM 148. From operation 314, the method 300 proceeds to operation 312. The method 300 can end at operation 312.

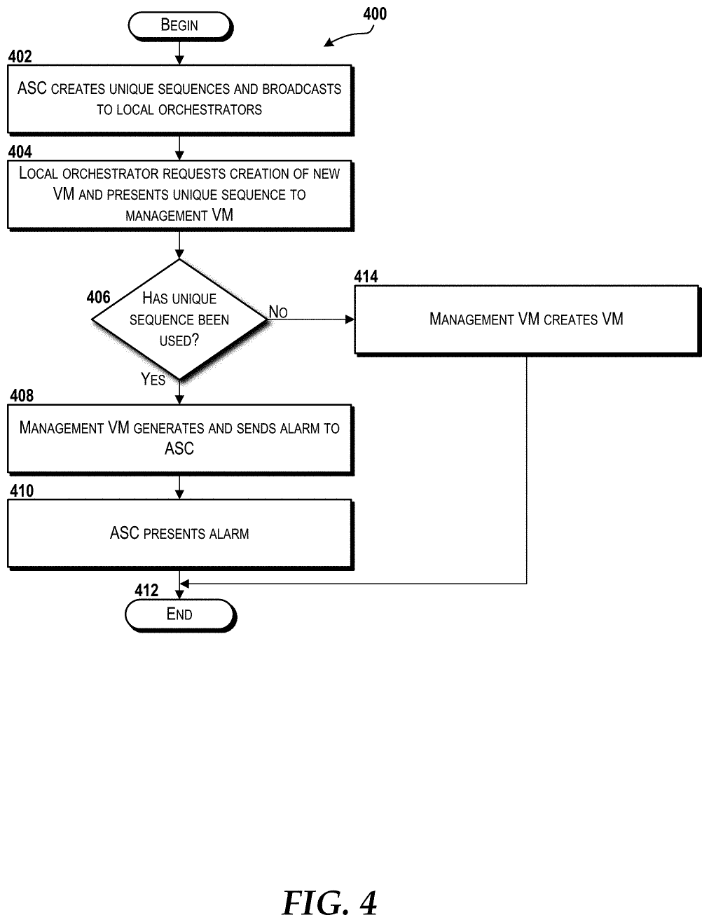

Turning now to FIG. 4, another method for mitigating VM orchestration spoofing will be described, according to an illustrative embodiment. The method 400 will be described with additional reference to FIG. 1B. The method 400 begins and proceeds to operation 402. At operation 402, the ASC 126 creates the unique sequences 154 and broadcasts the unique sequences 154 to the local orchestrators 120. From operation 402, the method 400 proceeds to operation 404. At operation 404, the local orchestrator 120 requests creation of the new VM 136 and presents the unique sequence 154 to the management VM 148.

From operation 404, the method 400 proceeds to operation 406. At operation 406, the management VM 148 determines if the unique sequence 154 has been used. If the management VM 148 determines that the unique sequence 154 has been used, the method 400 proceeds to operation 408. At operation 408, the management VM 148 generates and sends am alarm to the ASC 126. From operation 408, the method 400 proceeds to operation 410. At operation 410, the ASC 126 presents the alarm. From operation 410, the method 400 proceeds to operation 412. At operation 412, the method 400 can end.

Returning to operation 406, if the management VM 148 determines that the unique sequence 154 has not been used, the method 400 proceeds to operation 414. At operation 414, the management VM 148 creates the new VM 136. From operation 414, the method 400 proceeds to operation 412. The method 400 can end at operation 412.

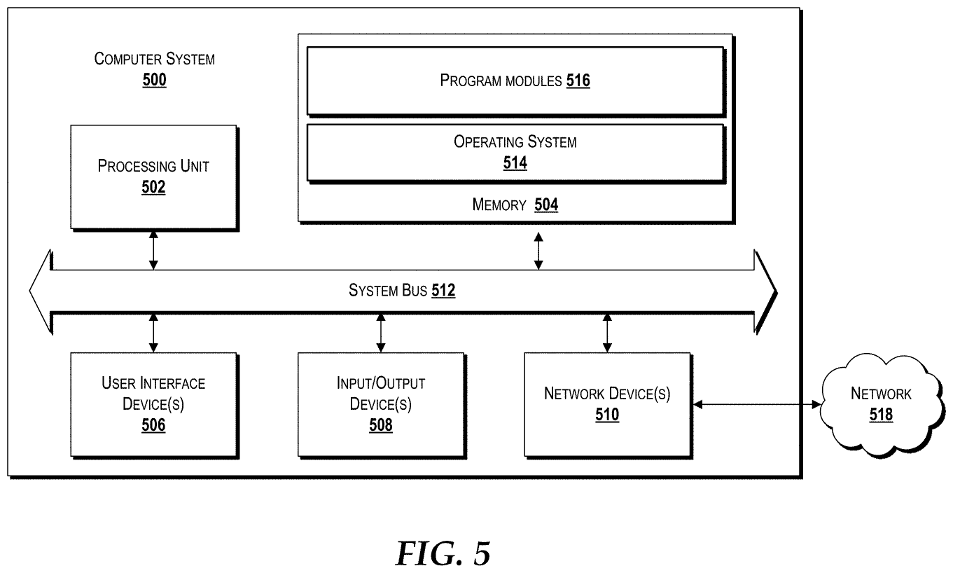

Turning now to FIG. 5, a block diagram illustrating an example computer system 500 capable of implementing aspects of the embodiments presented herein. In some embodiments, the hardware resources can be configured the same as or similar to the computer system 500. In some embodiments, the master orchestrator and/or one or more of the local orchestrators can be configured the same as or similar to the computer system 500. In some embodiments, the ASC 126 can be configured the same as or similar to the computer system 500. In some embodiments, the service(s) can be provided, at least in part, by one or more systems that are configured the same as or similar to the computer system 500.

The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 502 can be a single processing unit or a multiple processing unit that includes more than one processing component. Processing units are generally known, and therefore are not described in further detail herein.

The memory 504 communicates with the processing unit 502 via the system bus 512. The memory 504 can include a single memory component or multiple memory components. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 516 may include various software and/or program modules described herein. In some embodiments, the program modules 516 can include the ASC or components thereof, such as the testing module and/or the machine learning module. In some embodiments, the program modules 516 can include the master orchestrator, and in particular, software that provides the functionality of the master orchestrator to perform operations described herein. Similarly, the program modules 516 can include the local orchestrator(s), and in particular, software that provides functionality of the local orchestrators to perform operations described herein. The program modules 516 can also include other software components described herein. In some embodiments, multiple implementations of the computer system 500 can be used, wherein each implementation is configured to execute one or more of the program modules 516. The program modules 516 and/or other programs can be embodied in computer-readable media containing instructions that, when executed by the processing unit 502, perform the methods 200, 300, 400 described herein. According to embodiments, the program modules 516 may be embodied in hardware, software, firmware, or any combination thereof.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media, and therefore should be construed as being directed to “non-transitory” media only.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer.

The network devices 510 enable the computer system 500 to communicate with other networks or remote systems via a network 518. Examples of the network devices 510 include, but are not limited to, a modem, a radio frequency (“RF”) or infrared (“IR”) transceiver, a telephonic interface, a bridge, a router, or a network card. The network 518 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 518 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 6, an illustrative NFV platform 600 will be described, according to an illustrative embodiment. The NFV platform 600 includes a hardware resource layer 602, a hypervisor layer 604, a virtual resource layer 606, a virtual function layer 607, and a service layer 608. While no connections are shown between the layers illustrated in FIG. 6, it should be understood that some, none, or all of the components illustrated in FIG. 6 can be configured to interact with one other to carry out various functions described herein. In some embodiments, the components are arranged so as to communicate via one or more networks. Thus, it should be understood that FIG. 6 and the remaining description are intended to provide a general understanding of a suitable environment in which various aspects of the embodiments described herein can be implemented and should not be construed as being limiting in any way.

The hardware resource layer 602 provides the hardware resources 110. In the illustrated embodiment, the hardware resource layer 602 includes one or more compute resources 114, one or more memory resources 112, and one or more other resources 116.

The compute resource(s) 114 can include one or more hardware components that perform computations to process data and/or to execute computer-executable instructions of one or more application programs, one or more operating systems, and/or other software. In particular, the compute resources 114 can include one or more CPUs configured with one or more processing cores. The compute resources 114 can include one or more GPUs configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 114 can include one or more discrete GPUs. In some other embodiments, the compute resources 114 can include CPU and GPU components that are configured in accordance with a co-processing CPU/GPU computing model, wherein the sequential part of an application executes on the CPU and the computationally-intensive part is accelerated by the GPU processing capabilities. The compute resources 114 can include one or more SoC components along with one or more other components, including, for example, one or more of the memory resources 112, and/or one or more of the other resources 116. In some embodiments, the compute resources 114 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more OMAP SoCs, available from TEXAS INSTRUMENTS of Dallas, Tex.; one or more customized versions of any of the above SoCs; and/or one or more proprietary SoCs. The compute resources 610 can be or can include one or more hardware components architected in accordance with an ARM architecture, available for license from ARM HOLDINGS of Cambridge, United Kingdom. Alternatively, the compute resources 114 can be or can include one or more hardware components architected in accordance with an x86 architecture, such an architecture available from INTEL CORPORATION of Mountain View, Calif., and others. Those skilled in the art will appreciate the implementation of the compute resources 114 can utilize various computation architectures, and as such, the compute resources 114 should not be construed as being limited to any particular computation architecture or combination of computation architectures, including those explicitly disclosed herein.

The memory resource(s) 112 can include one or more hardware components that perform storage/memory operations, including temporary or permanent storage operations. In some embodiments, the memory resource(s) 112 include volatile and/or non-volatile memory implemented in any method or technology for storage of information such as computer-readable instructions, data structures, program modules, or other data disclosed herein. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store data and which can be accessed by the compute resources 114.

The other resource(s) 116 can include any other hardware resources that can be utilized by the compute resources(s) 114 and/or the memory resource(s) 112 to perform operations described herein. The other resource(s) 116 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 602 can be virtualized by one or more hypervisors 616A-616N (also known as “virtual machine monitors”) operating within the hypervisor layer 604 to create virtual resources that reside in the virtual resource layer 606. The hypervisors 616A-616N can be or can include software, firmware, and/or hardware that alone or in combination with other software, firmware, and/or hardware, creates and manages virtual resources 617A-617N operating within the virtual resource layer 606.

The virtual resources 617A-617N operating within the virtual resource layer 606 can include abstractions of at least a portion of the compute resources 114, the memory resources 112, and/or the other resources 116, or any combination thereof. In some embodiments, the abstractions can include one or more virtual machines, virtual volumes, virtual networks, and/or other virtualizes resources upon which one or more VNFs 618A-618N can be executed. The VNFs 618A-618N in the virtual function layer 607 are constructed out of the virtual resources 617A-617N in the virtual function layer 607. In the illustrated example, the VNFs 618A-618N can provide, at least in part, one or more services 620A-620N in the service layer 608.

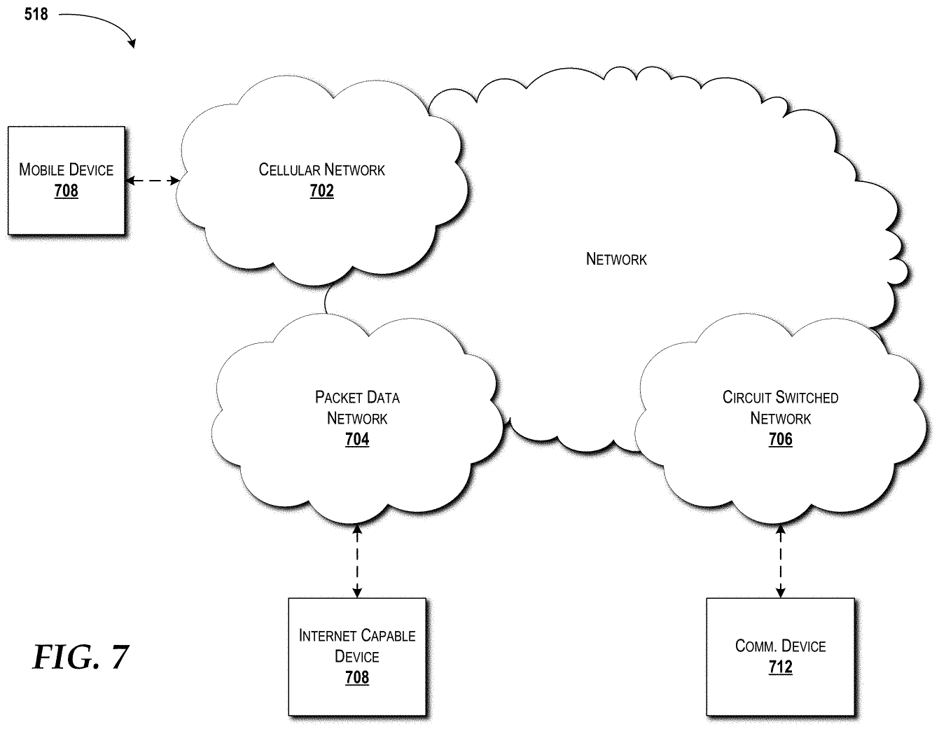

Turning now to FIG. 7, details of a network 518 are illustrated, according to an illustrative embodiment. The network 518 includes a cellular network 702, a packet data network 704, and a circuit switched network 706. In some embodiments, the virtualization platforms 100A, 100B can operate in communication with network 518.

The cellular network 702 can include various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to the cellular network 702. The cellular network 702 can be configured as a GSM) network and can provide data communications via GPRS and/or EDGE. Additionally, or alternatively, the cellular network 702 can be configured as a 3G Universal Mobile Telecommunications System (“UMTS”) network and can provide data communications via the HSPA protocol family, for example, HSDPA, EUL, and HSPA+. The cellular network 702 also is compatible with 4G mobile communications standards such as LTE, 5G mobile communications standards, or the like, as well as evolved and future mobile standards.

The packet data network 704 includes various systems, devices, servers, computers, databases, and other devices in communication with one another, as is generally known. In some embodiments, the packet data network 704 is or includes one or more WI-FI networks, each of which can include one or more WI-FI access points, routers, switches, and other WI-FI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 708 such as a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

Turning now to FIG. 8, a machine learning system 800 capable of implementing aspects of the embodiments disclosed herein will be described. In some embodiments, aspects of the ASC 126 can be enhanced through the use of machine learning and/or artificial intelligence applications. Accordingly, the ASC 126 can include the machine learning system 800 or can be in communication with the machine learning system 800.

The illustrated machine learning system 800 includes one or more machine learning models 802. The machine learning models 802 can include supervised and/or semi-supervised learning models. The machine learning model(s) 802 can be created by the machine learning system 800 based upon one or more machine learning algorithms 804. The machine learning algorithm(s) 804 can be any existing, well-known algorithm, any proprietary algorithms, or any future machine learning algorithm. Some example machine learning algorithms 804 include, but are not limited to, neural networks, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters. In some embodiments, the training parameters are selected modelers at the direction of an enterprise, for example. Alternatively, in some embodiments, the training parameters are automatically selected based upon data provided in one or more training data sets 806. The training parameters can include, for example, a learning rate, a model size, a number of training passes, data shuffling, regularization, and/or other training parameters known to those skilled in the art. The training data in the training data sets 806.

The learning rate is a training parameter defined by a constant value. The learning rate affects the speed at which the machine learning algorithm 804 converges to the optimal weights. The machine learning algorithm 804 can update the weights for every data example included in the training data set 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 808 in the training data set 806. A greater the number of features 808 yields a greater number of possible patterns that can be determined from the training data set 806. The model size should be selected to balance the resources (e.g., compute, memory, storage, etc.) needed for training and the predictive power of the resultant machine learning model 802.

The number of training passes indicates the number of training passes that the machine learning algorithm 804 makes over the training data set 806 during the training process. The number of training passes can be adjusted based, for example, on the size of the training data set 806, with larger training data sets being exposed to fewer training passes in consideration of time and/or resource utilization. The effectiveness of the resultant machine learning model 802 can be increased by multiple training passes.

Data shuffling is a training parameter designed to prevent the machine learning algorithm 804 from reaching false optimal weights due to the order in which data contained in the training data set 806 is processed. For example, data provided in rows and columns might be analyzed first row, second row, third row, etc., and thus an optimal weight might be obtained well before a full range of data has been considered. By data shuffling, the data contained in the training data set 806 can be analyzed more thoroughly and mitigate bias in the resultant machine learning model 802.

Regularization is a training parameter that helps to prevent the machine learning model 802 from memorizing training data from the training data set 806. In other words, the machine learning model 802 fits the training data set 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data set 806 can be adjusted to zero.

The machine learning system 800 can determine model accuracy after training by using one or more evaluation data sets 810 containing the same features 808′ as the features 808 in the training data set 806. This also prevents the machine learning model 802 from simply memorizing the data contained in the training data set 806. The number of evaluation passes made by the machine learning system 800 can be regulated by a target model accuracy that, when reached, ends the evaluation process and the machine learning model 802 is considered ready for deployment.

After deployment, the machine learning model 802 can perform a prediction operation (“prediction”) 814 with an input data set 812 having the same features 808″ as the features 808 in the training data set 806 and the features 808′ of the evaluation data set 810. The results of the prediction 814 are included in an output data set 816 consisting of predicted data. The machine learning model 802 can perform other operations, such as regression, classification, and others. As such, the example illustrated in FIG. 8 should not be construed as being limiting in any way.

Based on the foregoing, it should be appreciated that concepts and technologies for VM orchestration spoofing attack mitigation have been disclosed herein. Although the subject matter presented herein has been described in language specific to computer structural features, methodological and transformative acts, specific computing machinery, and computer-readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject disclosure.

1. A method comprising:
determining, by an anti-spoofing controller, a target memory location in which to instantiate a new virtual machine;
determining, by the anti-spoofing controller, a challenge for a physically unclonable function associated with the target memory location;
providing, by the anti-spoofing controller, the challenge to the physically unclonable function;
in response to the challenge, receiving, by the anti-spoofing controller, an output value from the physically unclonable function;
storing, by the anti-spoofing controller, the output value from the physically unclonable function;
instructing, by the anti-spoofing controller, an orchestrator to instantiate the new virtual machine in the target memory location;
providing, by the anti-spoofing controller, the challenge to the new virtual machine, wherein the new virtual machine forwards the challenge to the orchestrator;
receiving, by the anti-spoofing controller, from the orchestrator, a response to the challenge; and
determining, by the anti-spoofing controller, whether the response passes the challenge.

2. The method of claim 1, further comprising, in response to determining, by the anti-spoofing controller, that the response does not pass the challenge, instructing a master orchestrator to decommission the orchestrator.

3. The method of claim 1, further comprising intercepting, by the anti-spoofing controller, a request for the new virtual machine.

4. The method of claim 1, wherein determining, by the anti-spoofing controller, the challenge for the physically unclonable function associated with the target memory location comprises determining, by the anti-spoofing controller, a plurality of challenges for the physically unclonable function associated with the target memory location.

5. The method of claim 4, wherein determining, by the anti-spoofing controller, the plurality of challenges for the physically unclonable function associated with the target memory location comprises determining, by the anti-spoofing controller, the challenge under a plurality of conditions.

6. The method of claim 1, wherein instructing, by the anti-spoofing controller, the orchestrator to instantiate the new virtual machine in the target memory location comprises instructing, by the anti-spoofing controller, the orchestrator to instantiate the new virtual machine in a quarantine portion of the target memory location.

7. The method of claim 6, further comprises, in response to determining, by the anti-spoofing controller, that the response passes the challenge, instructing a master orchestrator to remove the new virtual machine from the quarantine portion.

8. A computer-readable storage medium having computer-executable instructions stored thereon that, when executed by a processor of an anti-spoofing controller, cause the processor to perform operations comprising:
determining a target memory location in which to instantiate a new virtual machine;
determining a challenge for a physically unclonable function associated with the target memory location;
providing the challenge to the physically unclonable function;
in response to the challenge, receiving an output value from the physically unclonable function;
storing the output value from the physically unclonable function;
instructing an orchestrator to instantiate the new virtual machine in the target memory location;
providing the challenge to the new virtual machine, wherein the new virtual machine forwards the challenge to the orchestrator;
receiving, from the orchestrator, a response to the challenge; and
determining whether the response passes the challenge.

9. The computer-readable storage medium of claim 8, wherein the operations further comprise, in response to determining that the response does not pass the challenge, instructing a master orchestrator to decommission the orchestrator.

10. The computer-readable storage medium of claim 8, wherein the operations further comprise intercepting a request for the new virtual machine.

11. The computer-readable storage medium of claim 8, wherein determining the challenge for the physically unclonable function associated with the target memory location comprises determining a plurality of challenges for the physically unclonable function associated with the target memory location.

12. The computer-readable storage medium of claim 11, wherein determining the plurality of challenges for the physically unclonable function associated with the target memory location comprises determining the challenge under a plurality of conditions.

13. The computer-readable storage medium of claim 8, wherein instructing the orchestrator to instantiate the new virtual machine in the target memory location comprises instructing the orchestrator to instantiate the new virtual machine in a quarantine portion of the target memory location.

14. The computer-readable storage medium of claim 13, wherein the operations further comprise, in response to determining that the response passes the challenge, instructing a master orchestrator to remove the new virtual machine from the quarantine portion.

15. A system comprising:
a processor; and
a memory comprising computer-executable instructions that, when executed by the processor, cause the processor to perform operations comprising
determining a target memory location in which to instantiate a new virtual machine,
determining a challenge for a physically unclonable function associated with the target memory location,
providing the challenge to the physically unclonable function,
in response to the challenge, receiving an output value from the physically unclonable function,
storing the output value from the physically unclonable function,
instructing an orchestrator to instantiate the new virtual machine in the target memory location,
providing the challenge to the new virtual machine, wherein the new virtual machine forwards the challenge to the orchestrator,
receiving, from the orchestrator, a response to the challenge, and
determining whether the response passes the challenge.

16. The system of claim 15, wherein the operations further comprise, in response to determining that the response does not pass the challenge, instructing a master orchestrator to decommission the orchestrator.

17. The system of claim 15, wherein determining the challenge for the physically unclonable function associated with the target memory location comprises determining a plurality of challenges for the physically unclonable function associated with the target memory location.

18. The system of claim 17, wherein determining the plurality of challenges for the physically unclonable function associated with the target memory location comprises determining the challenge under a plurality of conditions.

19. The system of claim 15, wherein instructing the orchestrator to instantiate the new virtual machine in the target memory location comprises instructing the orchestrator to instantiate the new virtual machine in a quarantine portion of the target memory location.

20. The system of claim 19, wherein the operations further comprise, in response to determining that the response passes the challenge, instructing a master orchestrator to remove the new virtual machine from the quarantine portion.
